(19) United States
(12) Patent Application Publication
(10) Pub. No.: US 2025/0061786 A1
(43) Pub. Date: Feb. 20, 2025

(54) LIGHTING SYSTEM WITH MONITORS FOR ASSESSMENT OF PERSONAL FALL RISK

(71) Applicant: Christiana Care Health System, Inc., Wilmington, DE (US)

(72) Inventors: Elizabeth Dauphin, Wilmington, DE (US); Phillip Chan, Wilmington, DE (US); Elizabeth Shearon, Rising Sun, MD (US); Hayley Danielle Sweetser, Hockessin, DE (US); Michael Szeliga, Newark, DE (US)

(21) Appl. No.: 18/804,241

(22) Filed: Aug. 14, 2024

Related U.S. Application Data
(60) Provisional application No. 63/532,716, filed on Aug. 15, 2023.

(51) Int. Cl. G08B 5/36; F21V 23/00; F21V 33/00; F21Y 115/10; G08B 21/04; H05B 45/22; H05B 47/125

(52) U.S. Cl. CPC G08B 5/36; F21V 23/003; F21V 33/0076; G08B 21/043; G08B 21/0476; H05B 45/22; H05B 47/125; F21Y 2115/10

(57) ABSTRACT

A smart lighting device, and a system including one or more smart lighting devices, that are well-suited for use in at-home setting. The devices may be configured as night lights, and can provide continuous monitoring of a person in the at-home setting and provide alerts to the person of potential fall risk areas in the home. Further, the devices may provide alerts to others (other designated persons/organizations), e.g., in the event of a fall or fall risk. Further, the devices may recognize unknown persons in the home, and provide alerts to others. The system may be configured to route these alerts to according to user preference and/or a severity of the detected situation/alert.

### CROSS-REFERENCE TO RELATED APPLICATION

This application claims the benefit of priority under 35 U.S.C. § 119 (e) of U.S. Provisional Patent Application No. 63/532,716, filed Aug. 15, 2023, the entire disclosure of which is hereby incorporated herein by reference.

### FIELD OF THE INVENTION

The present invention relates generally to prevention of falls that may result in injuries to patients and others, and more particularly to a lighting system that is well-suited to provide for real-time monitoring of a person in an at-home environment, to assess fall risk and provide guidance for the avoidance of falls and fall-related injuries.

### DISCUSSION OF RELATED ART

Elderly persons, patients recuperating post-surgery, and persons with various afflictions have a heightened risk of falling and sustaining injuries as a result of a fall.

The risk of falling increases with age, but it can be affected by a number of factors, including: age (the risk of falling increases significantly after the age of 65, health conditions (certain health conditions, such as arthritis, diabetes, and heart disease, can increase the risk of falling, medications (some medications, such as sedatives and antidepressants, can increase the risk of falling), vision problems (vision problems can make it difficult to see obstacles and can increase the risk of falling, foot problems (foot problems such as pain or poor circulation can make it difficult to walk and can increase the risk of falling) and environmental hazards (hazards such as uneven surfaces, loose rugs, and poor lighting can increase the risk of falling).

Taking steps to reduce fall risk can keep a person safe and independent. Additionally, the cost of falls can be significant both to the individual who falls and to society as a whole. Falls can lead to a variety of injuries, including fractures, head injuries, and spinal cord injuries. These injuries can require hospitalization, surgery, and rehabilitation, which can be very costly.

In addition, falls can lead to lost productivity. As people who are injured may be unable to work, the total cost of falls in the United States is estimated to be $50 billion per year. This cost is borne by a variety of sources, including Medicare, Medicaid, private insurance, and out-of-pocket payments.

Falls are the leading cause of injury-related deaths in people over the age of 65, and they are a major cause of disability.

Currently, a patient may be monitored in a hospital, nursing home or other care setting in various ways, and typically by manual observation when a caregiver is present. In that manner, the caregiver can provide assistance that will help the patient to avoid falls.

What is needed is a device for monitoring a person in care settings, such as in the at-home setting, in a manner that can assess fall risk and provide guidance for the avoidance of falls and fall-related injuries even when a caregiver is not present.

### SUMMARY

The present invention provides a smart lighting device, and a system including one or more smart lighting devices, that are well-suited for use in at-home setting (e.g., in a person's residence). The smart lighting devices may be configured as night lights, and can provide continuous monitoring of a person in the at-home setting and can provide alerts to the person of potential fall risk areas in the home. Further, the smart lighting devices may provide alerts to others (other designated persons/organizations), e.g., in the event of a fall or fall risk. The system may be configured to route these alerts to others according to user preference and/or a severity of the detected situation/alert.

### BRIEF DESCRIPTION OF THE FIGURES

An understanding of the following description will be facilitated by reference to the attached drawings, in which:

FIG. 1 is a perspective view of a smart night light device in accordance with an exemplary embodiment of the present invention;

FIG. 2 is a schematic diagram of a plurality of smart lighting devices deployed in a networked computing environment, in accordance with an exemplary embodiment of the present invention;

FIG. 3 is a schematic diagram of an exemplary smart lighting device of FIGS. 1 and 2, in accordance with an exemplary embodiment of the present invention;

FIG. 4 is a schematic diagram of an exemplary centralized control system of FIG. 2;

FIG. 5 is a schematic diagram of a floor plan, showing mapping of risk zones, in accordance with an exemplary embodiment of the present invention; and

FIG. 6 is a schematic diagram illustrating diagrammatically a tiered alert system in accordance with an exemplary embodiment of the present invention.

### DETAILED DESCRIPTION

The present invention provides a smart lighting device 100, which in this exemplary embodiment is configured as a night light, that is well-suited for use in at-home setting (e.g., in a person's residence). The smart lighting device may be used as part of a system 500 that provides continuous monitoring of a person in the at-home setting and provides alerts to the person of potential fall risk areas in the home. Further, the smart lighting devices 100 may provide alerts to others (other designated persons/organizations), e.g., in the event of a fall or fall risk. The system may be configured to route these alerts to others according to user preference and/or a severity of the detected situation/alert.

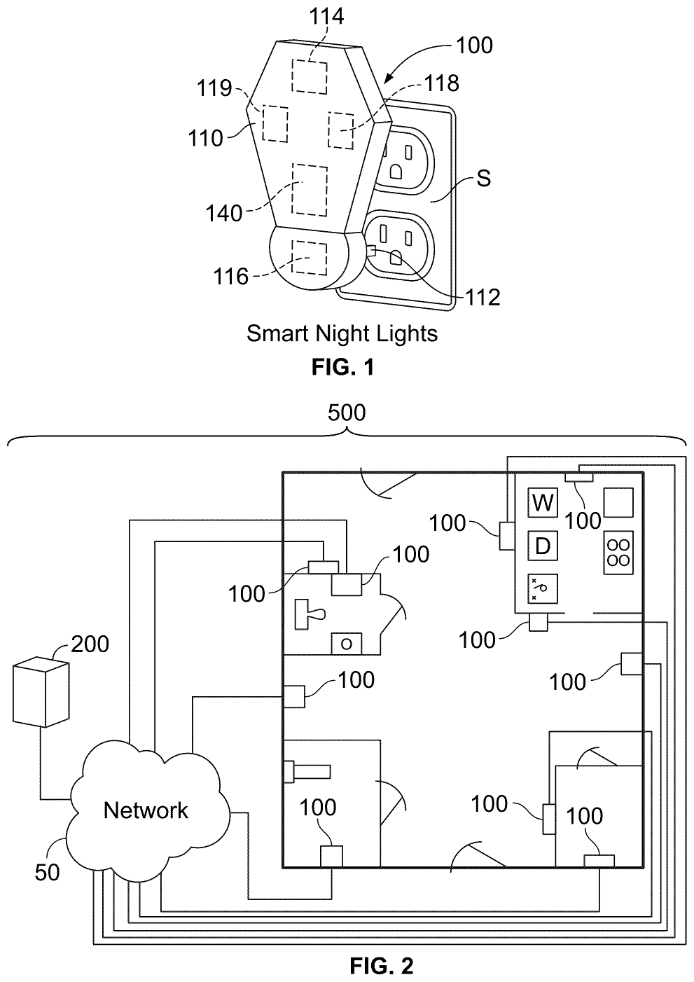

More particularly, the exemplary smart lighting device 100 that has a dual functionality. First, the exemplary smart night light device 100 is shaped and/or configured to have a form factor consistent with a conventional night light for general illumination purposes and is thus well-suited for use in home/residential settings, and thus may generally include a housing 110, a plug 112 for receipt in an electrical socket S to receive building mains power to power the device, and a light source 114, such as an LED light source, as will be appreciated from FIG. 1. Although not required, the light source 114 may be configured to provide sufficient brightness for general illumination purposes of a nearby environment when the smart lighting device 100 is configured as a night light device. The device 100 may include a battery 115 to serve as an alternative power source in the event of a disruption of building mains power.

Second, in accordance with the present invention, the device 100 further includes components enabling the devices to perform continuous home monitoring of people who are at high risk of falling, including in their homes. More particularly, each of the smart night light devices further includes an imaging device 116, a control engine 140.

By way of example, the imaging device 116 may comprise a digital camera, a laser/LiDAR, radar, or other imaging device having a sensor configured to observe a person's bodily movements in three-dimensional space while that person is moving (e.g., ambulating) within the home, within the field of “view” of each device 100.

In certain embodiments, imaging and/or other data is processed remotely, e.g., at a separate device remotely located from the devices 100. Accordingly, in such an embodiment, each device 100 may include a transmitter/transceiver or other data communication device 118 for use to transmit data.

The separate device may be a “master” smart night light device including certain data processing modules, or may be an external centralized control system computing device 200 including such data processing modules, as discussed in greater detail below.

In other embodiments, each device may perform some or part of the data processing, and therefore may include data processing modules. By way of example, the data processing modules may include a personal assessment module 180/280, an environmental assessment module 185/285, a lighting control module 190/290 and/or a notification module 195/295 capable of performing data analyses in accordance with the present invention, as discussed in greater detail below.

Accordingly, in some embodiments, one or more of the data processing modules may be integrated into each smart lighting device. In other embodiments, components of the smart lighting device described above may be integrated into the external device, such as the external centralized control system 200.

Preferably, a plurality of similar smart lighting devices 100 are placed throughout the at-home environment and operate in concert as part of a system 500 to ensure observability of movements throughout the entire (e.g., at-home) environment, as will be appreciated from the floor plan of FIG. 2. In this manner, for example, a person may be continuously monitored after passing out of the field of view of a first device 100 by passing into the field of view of a second device 100. Additionally, a second device 100 may be placed to avoid what may be a “blind spot” to the first device, e.g., due to furniture placement, walls, objects, etc. In certain embodiments, a device may be configured to provide an audible or visual cue to indicate that sensors are somewhat obscured, to prompt the user to place the device differently, or to place another device to supplement the field of view of the devices collectively.

The data gathered via each imaging device 116 is then used (and transmitted to an external device, if needed) by the personal assessment module 180/280 to make a determination as to whether the person has a heightened fall risk associated with the person's physical ability to ambulate. For example, gathered data may be used to assess a person's fall risk by capturing user biometrics, including data associated with the person's gait and balance, and processing that data according to an analytical model for processing such data and/or using a machine learning algorithm to assess a fall risk of the person as a function of the gathered data, e.g., and whether it exceeds a threshold for heightened fall risk. Various techniques are known in the art for using image data to assess gait, balance, etc. and determine an associated fall risk. This data may be collectedly continuously as the person moves throughout the at-home environment, and the associated data may be compiled into the person's biometric profile. In the example of FIGS. 1 and 2, the data gathered via the imaging device 116 may be processed via the Personal Assessment Module 180 of the night light device 100 or may be transmitted by the communication device 118 via the network 50 to a centralized control system 200 including the Personal Assessment Module 280.

The data gathered via the imaging device(s) may also be used (and transmitted to an external device, if needed) an Environmental Assessment Module 185/285 to make a determination as to whether the person has a heightened fall risk associated with certain characteristics of the at-home environment. For example, gathered data may be used to identify objects (e.g., clutter/objects on the floor that may pose a fall/trip hazard) within the environment that may contribute to a heightened fall risk and/or to categorize space of the at-home environment (e.g., room by room) that indicates areas of higher and lower risks (e.g., low/medium/high risk). In the example of FIGS. 1 and 2, the data gathered via the imaging device 116 may be processed via the Environmental Assessment Module 185 of the smart lighting device 100 or may be transmitted by the communication device 118 via the network 50 to a centralized control system 200 including the Environmental Assessment Module 285.

A Lighting Control Module 190/290 of the Control Engine 140/240 uses the personal fall risk assessment from the personal assessment module 180/280 and the categorizations of low/medium/high-risk areas from the environmental assessment module 185/285.

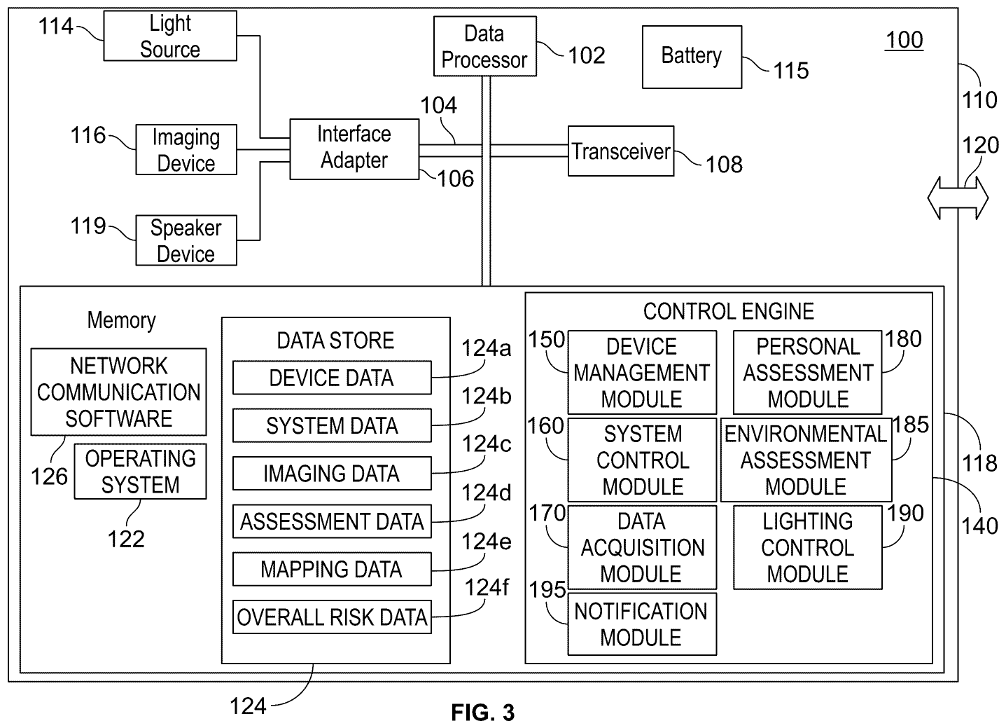

In certain embodiments, the LCM 190/290 may also correlate an assessed injury risk (due in part to a heightened fall risk associated with a person's ability to ambulate) and/or a heightened fall risk associated with aspects of the environment in which the person will ambulate and/or a heightened risk of injury due to aspects of the environment in the event of a fall (e.g., falling down the stairs may be different than falling in a living room) to areas of the environmental space by created a map/mapping. Accordingly, for example, the LCM 190/290 may categorize different areas of the environment as low-, medium-, or high-risk areas, and store such data as mapping data in a data store. FIG. 3 is a schematic diagram of a floor plan, showing mapping of risk zones, with color coding indicating the zones of different risk levels.

The LCM 190/290 controls the nature of the lighting delivered via the corresponding light source(s) 114 of one or more smart lighting devices 100 as a function of the determinations of overall risk in various environmental areas corresponding to placements of the smart lighting devices 100. For example, when a user enters an area within the range of a smart lighting device 100, the illumination of the smart lighting device 100 may change color to provide visual feedback to the user to indicate the severity of the injury/fall risk, from green (lowest fall/injury risk) to yellow (moderate fall/injury risk) to red (highest fall/injury risk), within the range of the smart night light device. Accordingly, for example, the LCM 190 may transmit a control signal to control the light source in a certain area to change the light source's color to indicate a risk level associated with that area, according to the mapping data. In certain embodiments, this may involve transmission of the control signal from an LCM 295 of the centralized computer system by the communication device 118 via the network 50 to a particular smart lighting device 100.

In this manner, the color coding of the color of the light provided by the smart lighting device provides instructions/feedback/alerts to the person, such that when the person is in an area of the at-home environment associated with a heightened risk level, the person may be guided by the yellow/red lighting of the smart lighting device 100 to take extra care, seek assistance from another person, and/or use assistive devices such as handrails, canes, walkers, etc.

Additionally, for areas of heightened fall/injury risk (e.g., moderate or high risk), the smart lighting device may provide a supplemental alert to the user. By way of example, the alert may be provided via an audible tone or spoken word message delivered via a speaker 170 of the smart lighting device 100.

In certain embodiments, the data gathered via the imaging device may also be used (and transmitted to, if needed) the EAM 185/285 to make a determination as to whether the person has fallen within the environment. For example, if the person stumbles or falls within range of one of the smart lighting devices, this may be detected by the EAM (e.g., by a rapid change in the “image” of the floor caused by a person lying on the floor, as reflected in the imaging data), and the control engine 140/240 may then issue an alert/notification by transmitting a signal to external computing devices of one or more people or organizations, as may be predefined by the person or in the system.

In certain embodiments, the alerts/notifications can be configured to be routed based on the severity of the alert, e.g., according to the System Data 124b. For example, a notification (e.g., text message, e-mail, phone call, etc.) may be sent to an associated caregiver if the person's fall risk continuously trends upwards or exceeds a threshold, or a call may be placed to emergency services (“911”) if the person has fallen and has not been able to get up.

FIG. 3 is a schematic diagram of an exemplary smart lighting device 100 of FIGS. 1 and 2, in accordance with an exemplary embodiment of the present invention. In other embodiments a simpler smart lighting device 100 may be provided that excludes some or all of the components discussed herein, as will be appreciated by those skilled in the art. However, in this example, the exemplary smart lighting device 100 includes conventional computing hardware storing and executing conventional software enabling operation of a general-purpose computing system, such as operating system software 122 and network communications software 126. Additionally, this exemplary smart lighting device 100 stores and executes additional computer software for carrying out at least one method in accordance with the present invention. By way of example, the network communication software 126 may include conventional data communications software, and the operating system software 122 may include iOS, Android, Windows, Linux and/or other software.

Accordingly, the exemplary smart lighting device 100 of FIG. 3 includes a data processor, such as a microprocessor (CPU) or other general-purpose processor 102 and a bus 104 employed to connect and enable communication between the processor 102 and the components of the smart lighting device 100 in accordance with known techniques. The exemplary smart lighting device 100 includes an interface adapter 106, which connects the processor 102 via the bus 104 to one or more interface devices, such as an LED/light source 112, imaging device 116, speaker device 119, and transceiver 108. These components may be housed in a common housing 110 supporting an electrical plug 112 and a back-up battery 115 operatively connected as power sources to these components, as described above. In certain embodiments, the smart lighting device 100 may not include all of these interface devices and other components.

The smart lighting device 100 may communicate with other devices, computers or networks of computers, for example via a communications channel 120, via the transceiver (which may include, for example, a network card and/or modem) 108. The smart night light device 100 may be associated with such other computers in a local area network (LAN) or a wide area network (WAN), and may operate as a server in a client/server arrangement with another computer, etc. Such configurations, as well as the appropriate communications hardware and software, are known in the art.

The bus 104 also connects the processor 102 to memory 118, which can include solid state or other memory. The smart night light device 100 further includes computer-readable, processor-executable instructions stored in the memory 118 for carrying out the methods described herein. Further, the memory 118 stores certain data, e.g. in one or more databases or other data stores 124 shown logically in FIG. 3 for illustrative purposes, without regard to any particular embodiment in one or more hardware or software components.

Further, as will be noted from FIG. 3, the exemplary smart lighting device 100 includes, in accordance with the present invention, a Control Engine (CE) 140, shown schematically as stored in the memory 118, which includes a number of modules providing functionality in accordance with the present invention, as discussed in greater detail below. These modules may be implemented primarily by software including microprocessor-executable instructions stored in the memory 118 of the smart lighting device 100. Optionally, other software may be stored in the memory 118 and and/or other data may be stored in the data store 124 and/or memory 118.

As referenced above, the smart lighting device (or centralized computing system 200) processes the data received from the imaging device 116 to perform a personal assessment of a person's walking ability, gait, steadiness, use of assistive devices, etc., and to perform an environmental assessment of the person's environment to identify high/low risk areas, etc., and sends a control signal that controls a light source 114 of a smart lighting device 100 to illuminate to provide an appropriate warning prompt to the person, and/or sends a control signal to prompt a caregiver to provide assistive and/or interventional care.

Accordingly, as shown in FIG. 3, the exemplary CE 140 of the exemplary smart lighting device 100 includes a Device Management Module (DMM) 150. The DMM 150 is responsible for tracking of data relating to the identity of a smart lighting device, such as a unique smart lighting device identifier and/or other components/aspects of operation of the smart lighting device 100. Accordingly, the DMM 150 may retrieve data from and/or store data in the Data Store 124 as Device Data 124a. This allows each smart lighting device 100 to be addressed/controlled individually in an identifiable manner, e.g., to control illumination of each smart lighting device independently of others, or as part of a group, etc.

Further, as shown in FIG. 3, the exemplary CE 140 of the exemplary smart lighting device 100 includes a System Control Module (SCM) 160. The SCM 150 is responsible for tracking of data relating to the configuration of one or more of the smart lighting devices and the system in which they operate, e.g., whether the system includes a centralized control system 200, network addresses, which components are included and/or where data needs to be sent for processing, etc. and/or other aspects to create, store and/or retrieve/send a wearer/user-specific profile for the smart lighting device 100/system 500. Accordingly, the SCM 160 may retrieve data from and/or store data in the Data Store 124 as System Data 124b. This allows the components of the system 500 to operate in concert to provide the functionality described herein.

Further, as shown in FIG. 3, the exemplary CE 140 also includes a Data Acquisition Module (DAM) 170. The DAM 170 is responsible for receiving imaging data from the imaging device 116 and storing such data in the Data Store 124 as Imaging Data 124c. The Imaging Data 124c may be stored in a manner to associate it with a particular smart lighting device to which it pertains, as that person is identified in the Device Data 124a. This allows the received Imaging Data 124c for a particular smart lighting device to be processed to perform a personal assessment for that person using the applicable Imaging Data 124c.

Further still, as shown in FIG. 3, the exemplary CE 140 also includes a Personal Assessment Module (PAM) 180. The PAM 180 is responsible for processing imaging data from the Imaging Device 116, etc. (which may involve use of the general-purpose processor 102 and/or retrieving of appropriate Imaging Data 124c from the Data Store 124, and/or from multiple imaging devices 116 of multiple smart lighting devices 100). More particularly, PAM 180 is responsible for processing the imaging data to assess the person's walking ability, gait, steadiness, etc. as a function of the imaging data. In certain embodiments, the PAM 180 is responsible for processing the imaging data to determine whether the person is using an assistive device, such as a walker or cane, and to account for such usage in assessing the person's fall risk as a function of the person's walking ability.

Imaging data may be continuously gathered across one or more s smart lighting devices and be repeatedly assessed by the PAM 180 over time.

Results of the personal assessment may be stored as Assessment Data 124d in the Data Store 124.

In this example shown in FIG. 3, the CE 140 further includes an Environmental Assessment Module (EAM) 185, although in certain embodiments this module may be omitted. The EAM 185 is responsible for processing imaging data from the Imaging Device 116, etc. (which may involve use of the general-purpose processor 102 and/or retrieving of appropriate Imaging Data 124c from the Data Store 124, and/or from multiple imaging devices 116 of multiple smart lighting devices 100). More particularly, EAM 180 is responsible for processing the imaging data to assess the environment in which the smart lighting devices 100 are positioned, to identify clutter/items on the floor, stairs, and other hazards that may present a fall risk, and to classify areas as higher or lower risk areas (e.g., low/medium/high risk areas) as a function of the imaging data.

In certain embodiments, the EAM 185 is responsible for processing the imaging data to determine whether a person has fallen and is sitting/lying on the floor. In such embodiments, this may result in transmission of a control signal to a caregiver/care provider to call for assistance in the event of a fall, etc.

Further still, as shown in FIG. 3, the CE 140 further includes a Lighting Control Module (LCM) 190. The LCM 190 is responsible for determining overall fall risk and in areas around each smart night light device as an area of higher or lower risk (e.g., as a low/medium/high risk area) and sending a control signal, e.g., locally on the same smart lighting device or from the centralized computer 200 via the network 50 in instances in which this function is performed at the centralized computer 200) using the Assessment Data 124d and Mapping Data 124e received from the data. Accordingly, the LCM 190 may process such data in combination to determine an overall fall risk as a function of such data, and to determine the level of risk, and to store such data as Overall Risk Data 124f in the Data Store 124. The LCM 190 thereby determines the type of illumination (e.g., green, yellow, red for low/medium/high risk, in this exemplary embodiment) at each smart lighting device, to support sending of appropriate control signals to one or more light sources 114 of one or more smart lighting devices to control illumination of the light sources in a color-coded fashion at each smart lighting device to provide appropriate color-coded warning notices/signals to the person in the environment via the illumination of the light sources of the smart lighting devices, for each person and/or set of night light devices, e.g., as may be reflected in the System Data 124b.

In certain embodiments, the LCM 195 may be configured to calculate overall fall risk to include consideration of real time biometrics (e.g., walking ability/gait/unsteadiness, etc.), whether the user is currently using an assistive device (e.g., a walker or cane), a consideration of environmental risks/obstacles that may lead to falls, and/or a history of falls within the range of the night light sensor device.

Further still, as shown in FIG. 3, the CE 140 further includes a Notification Module (NM) 195. The NM 195 is responsible for transmitting the necessary control signals. Accordingly, the NM 195 works in concert with the PAM 180 (e.g., to send a control signal to issue an instructive alert via a speaker 119 of a smart lighting device, such as a reminder to use a walker, cane or other assistive device in the event that the PAM detects poor walking ability, gait problems, unsteadiness etc.) and/or the EAM 185 (e.g., to issue a notification to a caregiver/care provider/emergency services in the event that the EAM 185 detects the person lying on a floor after a fall), e.g., using Assessment Data 124d, Mapping Data 124e and/or Overall Fall Risk Data 124f stored in the Data Store 124 in association with the particular person. Further, these control signals may be sent to particular smart lighting devices and/or to computing devices, etc. of particular care providers, etc. as a function of the Device Data 124a and System Data 124b stored in the Data Store 124 for a particular person.

In certain embodiments, the smart night light devices may be used for home monitoring purposes to detect strangers/potential intruders and/or other unwanted persons. In such embodiments, the data gathered via the imaging device is also be used (and transmitted to, if needed) the EAM 185 to identify people in the room (e.g., by processing the imaging data using facial recognition/comparison techniques), and to detect a new/unknown person by comparing the new person's facial/biometric or other information to facial/biometric or other information of other known persons. In the event of detection of a new/unknown person, the EAM 185 and NM 190 working in concert may issue an alert/notification by transmitting a control signal to external computing devices of one or more people or organizations, as may be predefined by the person or in the system, as indicated in the System Data 124b associated with the person. In certain embodiments, the alerts/notifications can be configured to be routed based on the severity of the alert, as reflected in the System Data 124b.

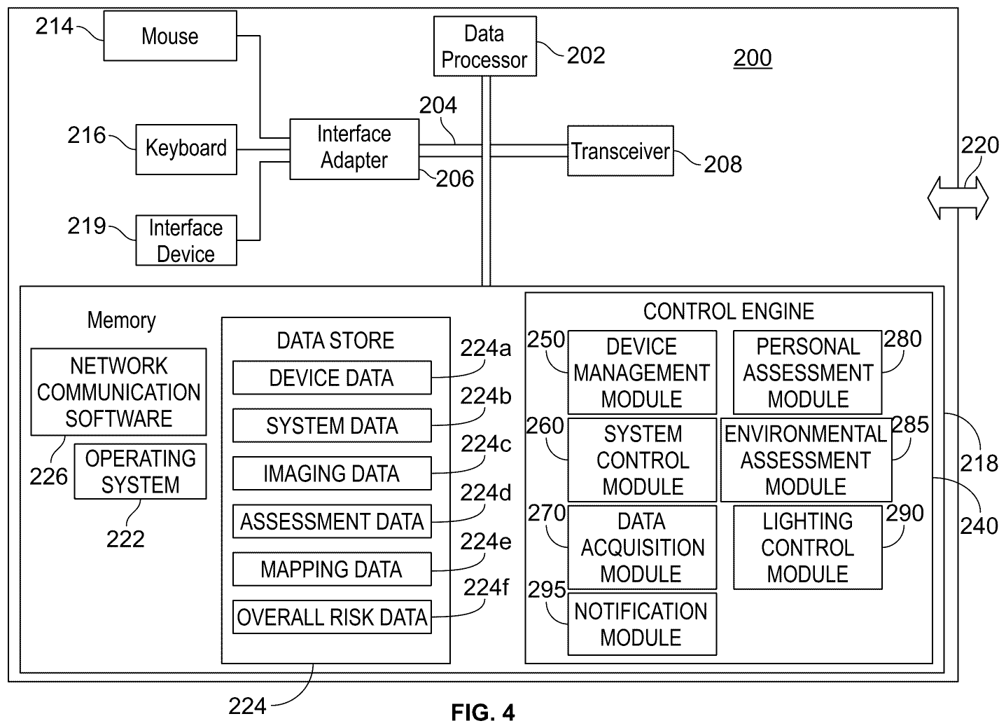

In certain embodiments, some or all of the hardware, software and/or functionality may be implemented at a centralized control system 200 (having some or all of the components shown in reference to the smart lighting device 100 in FIG. 3, similar to those described above with reference to FIG. 3), such that at least some of the processing described above may instead be performed at the centralized control system 200. In this embodiment, the centralized control system 200 includes a mouse 214, keyboard 216 and other interface devices 219 operatively coupled to the interface adapter 206 via the bus 204. FIG. 4 is a schematic diagram of an exemplary centralized control system of FIG. 2. For example, in certain embodiments, the PAM 180, EAM 185, LCM 190 and/or NM 195 may be provided at the central computerized system 200 instead of, or in addition to, at each smart lighting device 100. In such an embodiment, the centralized control system 200 may transmit the relevant control signals via a network, as will be appreciated from FIG. 2.

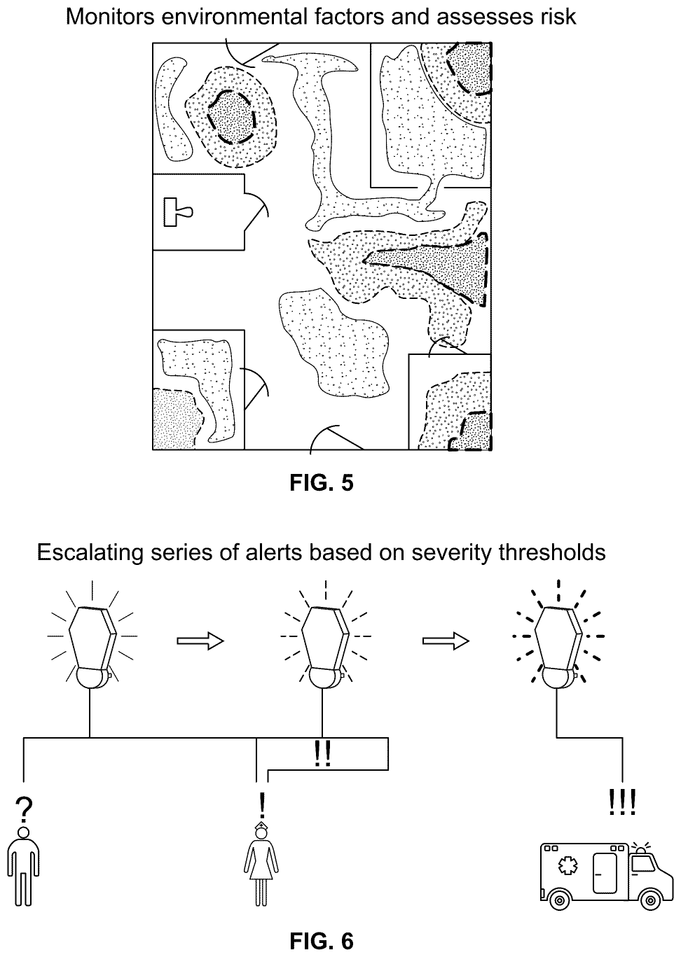

FIG. 5 is a schematic diagram illustrating diagrammatically a tiered alert rubric in accordance with an exemplary embodiment of the present invention. For example, in FIG. 5, a green (low) risk level may be associated with alerts being provided only to the person (e.g., via the speaker device 119 and/or light source 114), if at all, a yellow (medium) risk level may be associated with alerts provided to a nurse/caregiver as well as the person (e.g., via the light source 114 and control signals sent via a network to the nurse/caregivers' computing device to provide a suitable alert), and a red (high) risk level may be associated with alerts provided to an ambulance dispatch station (e.g. via the light source 114 and control signals sent via a network to a computing device of the ambulance dispatch station).

In use, multiple smart lighting devices 100 may be inserted into building mains power receptacles to monitor areas of the home or other environment. Preferably, sufficient multiple smart lighting devices 100 are placed such that most of all of the environment are within the fields of view of the devices in somewhat of a continuous mesh-like arrangement, so that the person can be continuously monitored while moving throughout the environment by a set of smart lighting devices, operating collaboratively/collectively. The light sources of each individual smart lighting device are controlled (by a control engine 140) to illuminate to indicate a fall risk level in the area of each smart lighting device. Accordingly, a person moving throughout the environment may be alerted, for example, that a certain area is high risk (e.g., indicated by red illumination), such that an assistive device may be used. By way of example, this may be the result of an identification/assessment of items/objects/aspects in the environment that pose a fall risk, such as steps, floor clutter/tripping hazards, etc. If the smart lighting device detects walking difficulties, unsteadiness, gait problems, etc. an audible alert may be issued via a speaker of the smart lighting device (e.g., such as an alert message reminding the person to use an assistive device in a high-risk area). Similarly, other areas may be indicated as low risk areas (e.g., indicated by green illumination). Further, the devices may detect that a fall has occurred, and alert a caregiver and/or emergency services. Further still, the devices may detect an unknown person and alert a caregiver, etc. Accordingly, the system provides for real time monitoring of environmental and physical fall risk factors in a person's environment, and is suitable for use in at-home environments, and real time alerts to the person and to others that can render assistance to the person.

It should be noted that although the devices are generally described herein as smart night light devices, in other embodiments, the smart lighting devices may have somewhat similar structure, but may not function or be configured as a night light. In other words, they may include light sources/displays for displaying risk levels, but the light source may not function to provide general floor/environmental illumination, as a night light generally does.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A smart lighting device comprising:
a housing;
a light source supported on said housing;
an imaging device supported on said housing and operable to gather imaging data corresponding to a person's fall risk in a region adjacent said housing; and
a control engine operatively coupled to said light source and said imaging device and operable to provide a control signal to said light source to control illumination of said light source as a function of data gathered by said imaging device.

2. The smart lighting device of claim 1, wherein said control engine comprises a personal assessment module operable to perform an analysis of data gathered by said imaging device to assess a fall risk to a person as a function of personal characteristics of the person as observed by said imaging device.

3. The smart lighting device of claim 1, wherein said control engine comprises a personal assessment module operable to perform an analysis of data gathered by said imaging device to assess a fall risk to a person as a function of whether said person is using a walking assistance device as observed by said imaging device.

4. The smart lighting device of claim 1, wherein said control engine comprises a personal assessment module operable to perform an analysis of data gathered by said imaging device to assess a fall risk to a person as a function of walking ability, gait and balance of said person as observed by said imaging device.

5. The smart lighting device of claim 1, wherein said control engine comprises an environmental assessment module operable to perform an analysis of data to assess a fall risk to the person as a function of environmental characteristics of an environment of the person as observed by said imaging device.

6. The smart lighting device of claim 5, wherein said environmental assessment module is operable to categorize a risk level of the region adjacent said housing.

7. The smart lighting device of claim 5, wherein said environmental assessment module is operable to make a determination as to whether the person has fallen within the environment.

8. The smart lighting device of claim 7, further comprising:
a data communication device operable to transmit data to an external device; and
a notification module operable to transmit a control signal to the external device to provide an alert at the external device that the person has fallen within the environment.

9. The smart lighting device of claim 1, wherein said control engine comprises an environmental assessment module operable to perform an analysis of data to assess a fall risk to the person as a function of objects present in an environment as observed by said imaging device.

10. The smart lighting device of claim 5, further comprising:
a data communication device operable to transmit data to an external device; and
a notification module operable to transmit a control signal to the external device to provide an alert at the external device;
wherein said environmental assessment module is operable to process said imaging data to identify persons, to compare an identified person to characteristics of known persons, and to transmit a control signal to the external device to issue an alert if the identified person does not match one of the known persons.

11. The smart lighting device of claim 1, wherein said control engine is operable to control a color of illumination of said light source as a function of data gathered by said imaging device.

12. The smart lighting device of claim 1, wherein said control engine comprises:
a personal assessment module operable to perform an analysis of data gathered by said imaging device to assess a person fall risk to a person as a function of personal characteristics of the person as observed by said imaging device;
an environmental assessment module operable to perform an analysis of data to assess an environmental fall risk to the person as a function of environmental characteristics of an environment of the person as observed by said imaging device; and
a lighting control module operable to determine an overall fall risk to the person as a function of the personal fall risk and the environmental fall risk.

13. The smart lighting device of claim 12, wherein said lighting control module is operable to control a color of illumination of said light source as a function of said overall fall risk.

14. The smart lighting device of claim 1, further comprising an electrical power plug supported on the housing and configured for receipt in an electrical socket, said electrical power plug being operatively coupled to said light source, said imaging device and said control engine.

15. The smart lighting device of claim 1, wherein said housing is configured to have a form factor consistent with a conventional night light, and wherein said light source has a brightness in operation for general illumination purposes.

16. The smart lighting device of claim 1, wherein said imaging device is selected from a group consisting of a digital camera, a laser, a radar and a LIDAR device.

17. The smart lighting device of claim 1, further comprising a speaker supported on said housing for providing an audible alert signal.

18. The smart lighting device of claim 17, wherein said control engine is operable to provide a second control signal to control said speaker to provide said audible alert signal as a function of data gathered by said imaging device.

19. A system for monitoring of a person, the system comprising:
at least one smart lighting device, each smart lighting device comprising:
a housing;
a light source supported on said housing;
an imaging device supported on said housing and operable to gather imaging data corresponding to a person's fall risk in a region adjacent said housing;
a first data communication device operable to transmit data to, and receive data from, external devices; and
a centralized control system comprising:
a processor;
a memory;
a second data communication device operable to transmit data to, and receive data from, external devices;
executable instructions stored in the memory and executable by the processor to:
receive imaging data from said at least one smart lighting device;
process said imaging data to determine the person's fall risk in the region adjacent said housing of said at least one smart lighting device; and
transmit a control signal to said at least one smart lighting device to control illumination of its light source as a function of the person's fall risk in the region adjacent its housing.

20. The system for monitoring of a person of claim 19, wherein said centralized control system comprises a personal assessment module operable to perform an analysis of data gathered by said imaging device to assess a fall risk to a person as a function of whether said person is using a walking assistance device as observed by said imaging device.

21. The system for monitoring of a person of claim 19, wherein said centralized control system comprises a personal assessment module operable to perform an analysis of data gathered by said imaging device to assess a fall risk to a person as a function of walking ability, gait and balance of said person as observed by said imaging device.

22. The system for monitoring of a person of claim 19, wherein said centralized control system comprises an environmental assessment module operable to perform an analysis of data to assess a fall risk to the person as a function of environmental characteristics of an environment of the person as observed by said imaging device.

23. The smart lighting device of claim 19, wherein said centralized control system comprises an environmental assessment module operable to perform an analysis of data to assess a fall risk to the person as a function of objects present in an environment as observed by said imaging device.

24. The smart lighting device of claim 22, further comprising:
a data communication device operable to transmit data to an external device; and
a notification module operable to transmit a control signal to the external device to provide an alert at the external device;
wherein said environmental assessment module is operable to process said imaging data to identify persons, to compare an identified person to characteristics of known persons, and to transmit a control signal to the external device to issue an alert if the identified person does not match one of the known persons.

25. The system for monitoring of a person of claim 23, wherein said environmental assessment module is operable to categorize a risk level of the region adjacent said housing.

26. The system for monitoring of a person of claim 23, wherein said environmental assessment module is operable to make a determination as to whether the person has fallen within the environment.

27. The smart lighting device of claim 19, wherein said centralized control system is operable to control a color of illumination of said light source as a function of data gathered by said imaging device.

28. The system for monitoring of a person of claim 19, wherein said centralized control system comprises:
a personal assessment module operable to perform an analysis of data gathered by said imaging device to assess a person fall risk to a person as a function of personal characteristics of the person as observed by said imaging device;
an environmental assessment module operable to perform an analysis of data to assess an environmental fall risk to the person as a function of environmental characteristics of an environment of the person as observed by said imaging device; and
a lighting control module operable to determine an overall fall risk to the person as a function of the personal fall risk and the environmental fall risk.

29. The system for monitoring of a person of claim 28, wherein said lighting control module is operable to control a color of illumination of said light source as a function of said overall fall risk.

30. The system for monitoring of a person of claim 19, further comprising an electrical power plug supported on the housing and configured for receipt in an electrical socket, said electrical power plug being operatively coupled to said light source, said imaging device and said centralized control system.

31. The system for monitoring of a person of claim 19, wherein said housing is configured to have a form factor consistent with a conventional night light, and wherein said light source has a brightness in operation for general illumination purposes.

32. The system for monitoring of a person of claim 19, wherein said imaging device is selected from a group consisting of a digital camera, a laser, a radar and a LIDAR device.

33. The system for monitoring of a person of claim 19, further comprising a speaker supported on said housing for providing an audible alert signal.

34. The system for monitoring of a person of claim 33, wherein said centralized control system is operable to provide a second control signal to control said speaker to provide said audible alert signal as a function of data gathered by said imaging device.

35. A smart lighting device comprising:
a housing configured to have a form factor of a conventional night light;
a light source supported on said housing, said light source being operable to provide brightness for general illumination purposes;
an imaging device supported on said housing and operable to gather imaging data corresponding to a person's fall risk in a region adjacent said housing;
a speaker supported on said housing for providing an audible alert signal; and
a control engine operatively coupled to said light source and said imaging device, said control engine being operable to:
provide a first control signal to said light source to control a color of illumination of said light source as a function of a fall risk determined as a function of data gathered by said imaging device; and
provide a second control signal to said speaker to provide said audible alert signal as a function of a determination as to whether the person is using an assistive device as a function of data gathered by said imaging device.
